(19) United States
(12) Patent Application Publication
(10) Pub. No.: US 2001/0024500 A1
(43) Pub. Date: Sep. 27, 2001

(54) Battery with integrated light

(76) Inventor: Richard Sharpe, Woodridge, IL (US)

Correspondence Address: Curtis A. Vock, Esq., Lathrop & Gage, L.C., Suite 302, 4845 Pearl East Circle, Boulder, CO, 80301, US

(21) Appl. No.: 09/738,784

(22) Filed: Dec. 15, 2000

Related U.S. Application Data
(60) Provisional application No. 60/171,222, filed on Dec. 16, 1999.

(51) Int. Cl. H01M 2/10; H04M 1/00; H04M 9/00

(52) U.S. Cl. 379/424; 379/324

(57) ABSTRACT

The present invention is directed to an integrated battery for a portable telephone. The integrated battery includes a battery for the portable telephone and a flashlight powered by the battery. The battery has at least one exposed surface as mounted to the portable telephone and the flashlight is mounted to be substantially flush with the at least one exposed surfaces of the battery so as to project a beam of light axially of the portable telephone. The battery enclosure further includes an ON/OFF switch disposed on the at least one exposed surfaces of the battery.

### RELATED APPLICATION

This application is a non-provisional application which claims the priority of prior provisional application Ser. No. 60/171,222, entitled “BATTERY WITH INTEGRATED LIGHT”, filed Dec. 16, 1999, which is hereby incorporated by reference into this application.

### FIELD OF THE INVENTION

This invention relates to a battery enclosure that has an integrated light and, more particularly, a battery enclosure for a portable phone that has a light and a switch integrated into the battery enclosure to enable the battery enclosure to be retrofitted on existing portable phones.

### BACKGROUND

Many individuals enjoy the convenience of owning and using wireless, mobile or cellular telephones as a means to facilitate communications and to make telephone calls when a conventional line or permanent telephone is not within reach or when the individual is “on the go.” The sharp increase in demand over the years for wireless services and specifically wireless telephones highlights a growing trend of general acceptance for this mode of communication. It would be advantageous to provide a portable telephone with the ability to direct a beam of light to aid the user in night-time situations.

Numerous innovations for illuminated telephones have been provided in the prior art. For example, U.S. Pat. No. 4,618,917 to Lee et al. teaches the use of a light-producing element and a conductor element integrated into a hand-set apparatus of many standard telephone designs. U.S. Pat. No. 5,029,205 to Archer teaches a telephone handset that has a light bulb and has a special switch that allows the light to automatically illuminate upon using the phone. The switch changes from an open position to a closed one upon a change in the orientation of gravity. U.S. Pat. No. 5,237,607 to Diamantis teaches a plurality of fiber optic light guides for receiving light rays emanating from a light source and for directing these light rays to a plurality of translucent buttons. U.S. Pat. No. 5,587,645 to Sciammarella et al. teaches a battery charger having a night light for use with a cordless telephone. The battery charger is energized by being plugged into a standard AC outlet. When AC power is cut off and the photo transistor detects that the light level is below a predetermined level, the lamp is powered by the handset battery to provide illumination and to enable a user to locate the handset during low light conditions while it is being charged. Although these innovations may be suitable for the specific purposes they address, they do not teach a portable telephone having a flashlight built into the phone and powered by the phone.

U.S. Pat. No. 5,901,206 to Soon, however, teaches a portable phone having a flashlight built therein. Specifically, the flashlight is built into the top face of the telephone casing and is substantially flush with the portable phone casing. The flashlight is powered by the battery for the phone.

It is apparent that numerous innovations for illuminated telephones have been provided in the prior art. But, of the previous innovations, including the flashlight portable phone of Soon, is that the concept of having a flashlight for a portable phone is limited to new phones only since the flashlight is built into the encasement. None of the innovations enable the user to retrofit a portable telephone with the capacity to direct a beam of light. Given the vast number of portable telephones on the market, this inability to retrofit is a significant market that is not being met by the present technology.

Thus, what is needed is a battery enclosure that has integrated therein a light and switch to operate the light for operation with a portable telephones currently on the market.

### SUMMARY OF THE INVENTION

Accordingly, an object of the present invention is to provide a mobile telephone with flashlight that avoids the disadvantages of the prior art. Another object of the present invention is the ability to retrofit current portable telephones with the ability to direct a beam of light to illuminate an area immediately in front of the telephone. Still another object of the present invention is to provide a mobile telephone with flashlight that is simple to use.

These objects are attained by the present invention that provides an integrated battery for a portable telephone. The integrated battery includes a battery for the portable telephone and a flashlight powered by the battery. The battery has at least one exposed surface as mounted to the portable telephone. The flashlight is mounted to be substantially flush with one of the at least one exposed surfaces of the battery so as to project a beam of light axially of the portable telephone. The battery enclosure further includes an ON/OFF switch disposed on the at least one exposed surfaces of the battery. The portable telephone functions as a handle for the flashlight to be gripped in the palm of a hand, with the flashlight being activated when the portable telephone is gripped in the palm of the hand and a finger of the hand depresses the ON/OFF switch of the flashlight.

The novel features which are considered characteristic of the present invention are set forth in the appended claims. The invention itself, however, both as to its construction and its method of operation, together with additional objects and advantages thereof, will be best understood from the following description of the specific embodiments when read and understood in conjunction with the accompanying drawing.

### DETAILED DESCRIPTION OF THE INVENTION

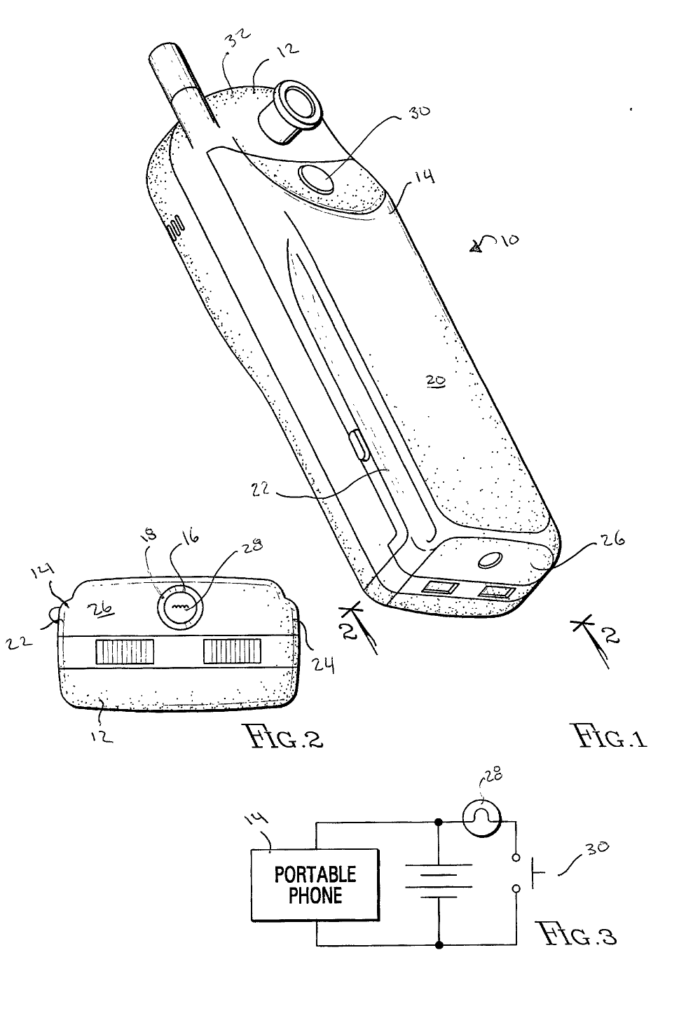

Referring now to the figures in which like numerals indicate like parts, and particularly to FIGS. 1 and 2, a portable phone with an integrated battery pack mounted thereto is shown generally at 10. The portable telephone with an integrated battery pack 10 comprises a portable telephone 12 that is powered by an integrated battery pack 14. The battery pack includes a flashlight 16 that extends axially from one of the exposed surfaces of the battery pack as mounted on the portable telephone 12 and a switch 30 to operate the flashlight.

The battery pack 14 mounts onto a portable telephone. The battery pack is a rechargeable battery that may be configured for any style portable telephone. As mounted, the battery pack includes exposed back face 20, side faces 22 and 24, and bottom face 26. The battery pack is preferably a 3.6 Volt, Nickel-Metal Hydride battery. This enables the user with approximately 1.9 to 3.09 hours of digital usage time, 90-190 hours of digital standby time or, alternatively, approximately 0.95 to 1.66 hours of analog usage time and 28.5 to 48 hours of analog standby time. The additional flashlight functionality of the battery pack does not severely impact the use of the battery pack. For instance, if the flashlight function of the integrated battery pack of the present invention is used for five minutes per charge, the flashlight only consumes less than 2.5% of the total battery capacity for that charge.

The flashlight 16 of the integrated battery pack 14 comprises a reflector 18 that is substantially flush with one of the exposed back face 20, side faces 22 and 24, and bottom face 26 of the battery pack as mounted on the portable telephone 12. Preferably, the reflector is mounted on a bottom face 20 of the battery pack as shown in FIG. 2. The flashlight further includes a bulb 28 cradled axially in the reflector 18 of flashlight 16 so as to project a beam of light axially of the portable telephone 10. The bulb is preferably a 3 volt, 250 milli-amp bulb that provides up to 3.4 hours of light.

It should also be understood that in an alternative embodiment of the present integrated battery pack, a light-emitting diode is used as the light. This LED is activated as an indicator for low-battery condition. This enables any cell phone to be retrofitted to provide the user with a visual sign that the battery needs recharging.

The battery pack 14 further includes an ON/OFF switch 30 that is preferably disposed on the exposed back face 20 of the battery pack. Preferably and as shown in FIG. 2, the switch 30 is in proximity of a top face 32 of the portable telephone 12 such that the portable telephone 12 functions as a handle to be gripped in the palm of the hand, and with the flashlight 16 being activated, and projecting a beam of light axially of the portable telephone 10. As the portable telephone 12 is gripped in the palm of the hand, the switch is ergonomically placed such that a finger of the hand depresses the ON/OFF switch 30 of the flashlight 16.

The circuit of the integrated battery pack can best be seen in FIG. 3, and as such will be discussed with reference thereto. The portable telephone 12 and the bulb 28 of the flashlight 16 are in parallel electrical communication with, and powered by, the battery 13 of the portable telephone 12 so as to allow the portable telephone 12 and the flashlight 16 to be powered by the battery pack 14 of the present invention. Toggle switch 30 is in serial electrical communication with the bulb 28 of the flashlight 24.

While the invention has been illustrated and described as embodied in a mobile telephone with flashlight, however, it is not limited to the details shown, since it will be understood that various omissions, modifications, substitutions and changes in the forms and details of the device illustrated and its operation can be made by those skilled in the art without departing in any way from the spirit of the present invention.

The invention claimed is:

1. A rechargeable battery pack for a portable telephone, the battery pack having at least one exposed surface as mounted on the portable telephone, the rechargeable battery pack comprises,
a battery for powering the portable telephone,
a light-emitting unit integrated into the battery pack and powered by the battery, the light-emitting unit being mounted to one of the at least one exposed surface of the battery pack, and
a switch for activating the light-emitting unit.

2. The battery pack of claim 1 wherein the light-emitting unit is a flashlight comprising a reflector and a bulb cradled axially in said reflector of said flashlight so as to project a beam of light axially of said portable telephone as the battery pack is mounted on said portable phone.

3. The battery pack of claim 2 wherein the reflector is substantially flush with one of the at least one exposed surface of the battery pack as mounted to the portable phone.

4. The battery pack of claim 1 wherein battery pack has an exposed back surface and an exposed bottom surface as mounted on the portable telephone, the light-emitting unit being located on the bottom surface to direct a beam of light axially outwardly from the bottom surface of the portable telephone.

5. The battery pack of claim 4 wherein the switch is placed on the back surface such that as the battery pack is mounted to the portable telephone the user of the portable telephone can hold the portable telephone and depress the switch on the back surface and direct a beam of light from the bottom surface of said battery pack.

6. The battery pack of claim 1 wherein the light-emitting unit is a light-emitting diode and wherein the battery of the battery pack has a capacity associated therewith, the switch of the battery pack being triggered at a condition of low battery capacity to indicate for a user of the battery pack that the battery is at low battery capacity.
